(19) United States
(12) Patent Application Publication
(10) Pub. No.: US 2022/0403110 A1
(43) Pub. Date: Dec. 22, 2022

(54) HIGHLY ELASTIC AND HEAT-RESISTANT POLYIMIDE FILM AND METHOD FOR PRODUCING SAME

(71) Applicant: PI Advanced Materials Co., Ltd., Chungcheongbuk (KR)

(72) Inventors: Sung-Yul BACK, Chungcheongbuk (KR); Kil-Nam LEE, Chungcheongbuk (KR); Ki-Hoon KIM, Chungcheongbuk (KR)

(21) Appl. No.: 17/776,674

(22) PCT Filed: Dec. 2, 2019
(86) PCT No.: PCT/KR2019/016851

§ 371 Date: May 13, 2022

(30) Foreign Application Priority Data
Nov. 13, 2019 (KR) 10-2019-0144767

(51) Int. Cl. C08G 73/10; C08K 5/521; C08J 5/18

(52) U.S. Cl. CPC C08G 73/1071; C08G 73/1021; C08G 73/105; C08K 5/521; C08J 5/18; C08J 2379/08

(57) ABSTRACT

Disclosed herein are a highly thick polyimide film that contains a reduced number of bubbles therein and exhibits high elasticity and high heat resistance, and a manufacturing method therefor. The polyimide film is obtained by imidizing a poly(amic acid) solution containing an acid dianhydride component including 3,3′,4,4′-benzophenonetetracarboxylic dianhydride (BTDA), 3,3′,4,4′-biphenyltetracarboxylic dianhydride (BPDA), and pyromellitic dianhydride (PMDA), and a diamine component including 4,4′-oxydianiline (ODA), para-phenylenediamine (p-phenylenediamine, PPD), and 3,5-diaminobenzoic acid (DABA), and contains a phosphorus (P)-based compound.

### TECHNICAL FIELD

The present disclosure relates to a polyimide film and, more specifically, to a highly thick polyimide film that contains a reduced number of bubbles therein and exhibits high elasticity and high heat resistance.

### BACKGROUND ART

Polyimide (PI), based on highly chemically stable imide rings in a robust aromatic backbone, is a polymeric material that has the highest levels of heat resistance, drug resistance, electric insulation, chemical resistance, and weather resistance among organic materials.

A polyimide film is in the spotlight as a material for various electronic devices demanding such properties.

Poly(amic acid) is dissolved in organic solvents, but polyimide is not. On the whole, thus, a form of a poly(amic acid) solution is adopted for processing polyimide and as such, is dried into desired films, molded articles, coats, and so on, followed by imidization.

Thermal stress occurring in the procedure of cooling polyimide films and laminates thereof from imidization temperatures to room temperature has been a cause of serious problems such as curling, delamination, cracking, etc.

Particularly, the thermal stress is seriously disadvantageous for high integration of electronic circuits and recruitment of a multilayer wiring board.

Although not leading to film delamination or cracking, thermal stress, if remaining in a multilayer board, remarkably degrades reliability of the device.

Expanding polyimide at a low rate is considered as a measure for reducing such thermal stress, but a polyimide with a low coefficient of thermal expansion generally has a robust linear main chain structure, thus suffering from the disadvantage of being poor in water vapor permeability and being prone to foaming according to film formation conditions.

With excessively dense molecular packing, the film is poor in water vapor permeability and bubbles (air, etc.) are frequently generated therein in the manufacture processes therefor.

Once generated, such bubbles have adverse influences on the surface roughness of the polyimide film as well as generally degrading electrical, optical, and mechanical properties of the polyimide film.

Therefore, there is a need for a solution that can reduce the generation of bubbles in a polyimide film having a low coefficient of expansion while allowing the polyimide film to retain high elasticity as well as intrinsic properties such as high heat resistance.

The matters described in this Background section are intended to enhance the understanding of the background of the present disclosure and may therefore include information that does not form the related art that is already known to a person skilled in the art.

### DISCLOSURE

### Technical Problem

Accordingly, the present disclosure aims to provide a highly thick polyimide film having high elasticity and high heat resistance.

Aspects of the present disclosure are not limited thereto. Additional aspects will be set forth in part in the description which follows, and will be apparent from the description to those of ordinary skill in the related art.

### Technical Solution

To accomplish the aim, an aspect of the present disclosure provides a polyimide film, obtained by imidizing a poly(amic acid) solution containing an acid dianhydride component including 3,3′,4,4′-benzophenonetetracarboxylic dianhydride (BTDA), 3,3′,4,4′-biphenyltetracarboxylic dianhydride (BPDA), and pyromellitic dianhydride (PMDA), and a diamine component including 4,4′-oxydianiline (ODA), para-phenylenediamine (p-phenylenediamine, PPD), and 3,5-diaminobenzoic acid (DABA),

wherein the 4,4′-oxydianiline is used at a content of 10 mol % to 30 mole, the p-phenylenediamine is used at a content of 50 mol % to 70 mol %, and the 3,5-diaminobenzoic acid is used at a content of 5 mol % to 25 mol %, based on a total of 100 mol % of the diamine component, and

the polyimide film comprises a phosphorus (P)-based compound.

Based on a total of 100 mol % of the acid dianhydride component, the 3,3′,4,4′-benzophenonetetracarboxylic dianhydride may be used at a content of 10 mol- to 30 mol-, the 3,3′,4,4′-biphenyltetracarboxylic dianhydride may be used at a content of 40 mol % to 70 mol %, and the pyromellitic dianhydride may be used at a content of 10 mol % to 50 mol %.

The phosphorus-based compound may be contained in an amount of 1.5% by weight to 4.5% by weight, relative to the solid content of the acid dianhydride component and the diamine component.

The phosphorus-based compound may be at least one selected from the group consisting of triphenyl phosphate (TPP), trixylenyl phosphate (TXP), tricresyl phosphate (TCP), resorcinol diphenyl phosphate, and ammonium polyphosphate.

The polyimide may have an elastic modulus of 6 GPa or higher, a surface roughness of 0.5 μm or less, and a thickness of 70 μm or greater.

In addition, the polyimide film may have less than 5 bubbles per 1 m² thereof.

Another aspect of the present disclosure provides a method for manufacturing a polyimide film, the method comprising the steps of:

(a) polymerizing an acid dianhydride including 3,3′,4,4′-benzophenonetetracarboxylic dianhydride (BTDA), 3,3′,4,4′-biphenyltetracarboxylic dianhydride (BPDA), and pyromellitic dianhydride (PMDA) with a diamine component including 4,4′-oxydianiline (ODA), p-phenylenediamine (PPD), and 3,5-diaminobenzoic acid (DABA) in an organic solvent to prepare a poly(amic acid);

(b) adding and mixing the poly(amic acid) of step (a) with an imidizing catalyst and a phosphorus (P)-based compound; and

(c) imidizing the poly(amic acid) of step (b),

wherein the 4,4′-oxydianiline is used at a content of 10 mol % to 30 mol %, the p-phenylenediamine is used at a content of 50 mol % to 70 mol %, and the 3,5-diaminobenzoic acid is used at a content of 5 mol % to 25 mol %, based on a total of 100 mol % of the diamine component.

A further aspect of the present disclosure provides a protective film and a carrier film, each including the polyimide film.

### Advantageous Effects

Being structured to have controlled ratios and solid contents of acid dianhydride and diamine components and contain a phosphorus-based compound, the polyimide film of the present disclosure exhibits high elasticity and high heat resistance, with an elastic modulus of 6 GPa or higher, a surface roughness of 0.5 μm or less, and a thickness of 70 μm or greater.

In addition, although being relatively thick with a thickness of 70 μm or greater, the manufactured polyimide film was observed to have less than 5 bubbles/m². The bubbles may vary in number depending on the content of the phosphorus-based compound, so that a highly thick, quality film can be obtained with no bubbles observed therein.

Such polyimide films exhibit particularly improved surface quality due to the lowered surface roughness and restrained bubble formation thereof in addition to excellent mechanical properties such as high elasticity, thus finding applications in various fields demanding such properties.

### BEST MODE FOR CARRYING OUT THE INVENTION

Terms and words used in the present specification and claims should not be limited to general or dictionary meanings, but are to be construed as meanings and concepts meeting the technical ideas of the present disclosure based on a principle that the present inventors may appropriately define the concepts of terms in order to describe their inventions in the best mode.

Therefore, the configurations of embodiments described herein are only one of the most preferred embodiments of the present disclosure and do not represent all the technical spirits of the present disclosure. Thus, it should be understood that there may be various equivalents and modification examples that can replace them at the time of filing the present application.

Singular forms as used herein include plural forms unless the context clearly indicates otherwise. It should be understood that the term “comprise”, “includes”, or “have”, etc., as used herein specifies the presence of implemented features, numerals, steps, components, or a combination thereof, but does not preclude the presence or addition of one or more other features, numerals, steps, components, or a combination thereof.

As used herein, the term “acid dianhydride” is intended to encompass precursors or derivatives thereof which may not fall within the scope of dianhydrides from a point of technical view, but nevertheless will react with diamine to form poly(amic acid)s which can be then converted into polyimides.

It should be understood that when an amount, concentration, or other value or parameter as used herein is given as an enumeration of a range, a preferable range, or preferable upper and lower values, all ranges formed with any upper limit or preferable values of any one pair and any lower limit or preferable values of any one pair are specifically disclosed, regardless of whether the range is disclosed separately.

When a range of numerical values is referred to herein, the range is intended to include endpoints thereof and all integers and fractions within that range, unless stated otherwise. It is intended that the scope of the present disclosure is not limited to specific values recited when the range is defined.

The polyimide film according to an embodiment of the present disclosure is obtained by imidizing a poly(amic acid) solution containing an acid dianhydride component including 3,3′,4,4′-benzophenonetetracarboxylic dianhydride (BTDA), 3,3′,4,4′-biphenyltetracarboxylic dianhydride (BPDA), and pyromellitic dianhydride (PMDA) with a diamine component including 4,4′-oxydianiline (ODA), p-phenylenediamine (PPD), and 3,5-diaminobenzoic acid (DABA), wherein the 4,4′-oxydianiline is used at a content of 10 mol % to 30 mol %, the p-phenylenediamine is used at a content of 50 mol % to 70 mol %, and the 3,5-diaminobenzoic acid is used at a content of 5 mol % to 25 mol %, based on a total of 100 mol % of the diamine component.

An increased content of p-Phenylenediamine, which is a stout monomer, confers a straighter structure on the resulting polyimide, contributing to an improvement in mechanical properties such as elastic modulus, etc.

When p-phenylenediamine is used in an amount less than the lower limit of the range based on the total mole of the diamine component, the highly thick polyimide film (70 μm or greater in thickness) may decrease in elasticity.

When p-phenylenediamine is used in an amount exceeding the upper limit of the range based on the total mole of the diamine component, particularly when the solid content is increased, gelling proceeds due to secondary bonding, making it difficult to produce highly thick polyimide films.

With the increase of thickness in the highly thick polyimide film including p-phenylenediamine, bubbles are more likely to be generated therein.

The increased generation of bubbles seems to be attributed to the fact that when synthesized with a more content of p-phenylenediamine, the polyimide chain becomes more linear and the bonding between the linear polyimide changes becomes strong, which leads to the difficulty in the vaporization of the solvent and water.

Bubbles generated in a polyimide film have a great negative influence on the appearance and mechanical properties of the polyimide film and are responsible for poor quality thereof. Even though excellent in other properties, a polyimide film having many bubbles generated therein is difficult to apply to practical articles.

In this regard, a phosphorus-based compound is added as a plasticizer which can increase flexibility between polyimide chains by affording a free volume to the strong polyimide chain-chain bond induced by p-phenylenediamine.

The addition of a phosphorus-based compound was observed to greatly reduce the number of bubbles formed in the polyimide film.

According to another embodiment of the present disclosure, the polyimide film may include an inorganic filler. Examples of the inorganic filler include silica (inter alia, spherical silica), titanium oxide, alumina, silicon nitride, boron nitride, calcium hydrogen phosphate, calcium phosphate, and mica.

The particle diameter of the filler is not particularly limited, but is determined according to desirable properties of the film and types of the filler to be added. Generally, the filler has a mean particle diameter of 0.05 to 100 μm, particularly 0.1 to 75 μm, more particularly 0.1 to 50 μm, even more particularly 0.1 to 25 μm.

When fillers have a particle diameter less than the lower limit of the range, modification effects thereof are insubstantially obtained. With a particle diameter exceeding the upper limit of the range, the fillers may greatly degrade the surface property or mechanical property.

The amount of the filler is not particularly limited, but may be determined according to desirable properties of the film and particle sizes of the filler. Generally, the filler is used in an amount of 0.01 to 100 parts by weight, particularly 0.01 to 90 parts by weight, and more particularly 0.02 to 80 parts by weight, based on 100 parts by weight of the polyimide film.

When the filler is used in an amount less than the lower limit of the range, modification effects thereof are little obtained. When used in an amount higher than the upper limit of the range, the filler is apt to greatly damage mechanical properties of the film. So long as it is known in the art, any method of adding the filler may be used without particular limitations.

The inorganic fillers included in the polyimide film give roughness to the surface of the polyimide film, thereby imparting anti-blocking properties that prevent the polyimide films from adhering to each other during production or use.

Inorganic fillers are typically used as additives for polyimide films. Among others, spherical silica particles have excellent anti-blocking properties.

As for spherical silica particles used as an inorganic filler, for example, their average diameter greater than 1 μm increases the surface roughness, which is likely to cause a scratch on the surface of an object in contact with the polyimide film, resulting in a product defect. The spherical silica particles with an average diameter below 0.1 μm do not induce anti-blocking properties that prevent a blocking phenomenon between films.

On the whole, spherical silica particles, if present in excess, aggregate to cause a defect on the film. When too little an amount of spherical silica particles is used, difficulties arise in the winding step because the films adhere to each other after the surface treatment of the films.

According to another embodiment of the present disclosure, the phosphorus-based compound, which has a plasticizer property useful for preventing bubble generation, may be contained in an amount of 1.5% by weight to 4.5% by weight, relative to the solid content of the acid dianhydride component and diamine compound used for the synthesis of the polyimide.

Less than 1.5% by weight of the phosphorus-based compound does not guarantee a sufficient effect of preventing bubble formation. The phosphorus-based compound used in an amount exceeding 4.5% by weight decreases the elasticity of the polyimide film.

Examples of the phosphorus-based compound include triphenyl phosphate (TPP), ammonium polyphosphate, trixylenyl phosphate (TXP), tricresyl phosphate (TCP), resorcinol diphenyl phosphate, and ammonium polyphosphate.

Inter alia, either or both of triphenyl phosphate (TPP) and ammonium polyphosphate are preferred, but with no limitations thereto. So long as it has the plasticizer property of affording a free volume to increase flexibility between polyimide chains and contributes to preventing bubble formation, any phosphorus-based compound can be employed.

The polyimide film according to an embodiment of the present disclosure is highly elastic and thick with an elastic modulus of 6 GPa or higher, a surface roughness of 0.5 μm or less, and a thickness of 70 pin or greater.

The elastic modulus of the polyimide film varies depending on the content of p-phenylenediamine (PPD) and may amount to 6 GPa or higher. The polyimide film with such a high elastic modulus can be applied to various fields and is suitable for use as a carrier film or a protective film.

Moreover, the polyimide film is 70 μm or greater in thickness and preferably 75 μm or greater in thickness.

The polyimide film has less than 5 bubbles per m². The number of bubbles in the polyimide film decreases with increasing of the content of the phosphorus-based compound. An appropriately controlled content of the phosphorus-based compound can maintain proper values for elastic modulus and surface roughness while minimizing the number of bubbles (no bubbles may be observed).

Another aspect of the present disclosure provides a method for manufacturing a polyimide film, the method comprising the steps of:

(a) polymerizing an acid dianhydride including 3,3′,4,4′-benzophenonetetracarboxylic dianhydride (BTDA), 3,3′,4,4′-biphenyltetracarboxylic dianhydride (BPDA), and pyromellitic dianhydride (PMDA) with a diamine component including 4,4′-oxydianiline (ODA), p-phenylenediamine (PPD), and 3,5-diaminobenzoic acid (DABA) in an organic solvent to prepare a poly(amic acid);

(b) adding and mixing the poly(amic acid) of step (a) with an imidizing catalyst and a phosphorus (P)-based compound; and

(c) imidizing the poly(amic acid) of step (b),

wherein the 4,4′-oxydianiline is used at a content of 10 mol % to 30 mol %, the p-phenylenediamine is used at a content of 50 mol % to 70 mol %, and the 3,5-diaminobenzoic acid is used at a content of 5 mol % to 25 mol %, based on a total of 100 mole of the diamine component.

The imidization of poly(amic acid) can be achieved by a thermal imidization process, a chemical imidization process, or a combination thereof. Here, the “thermal imidization process” refers to a process in which an imidization reaction is induced using a heat source, such as hot wind or an infrared dryer, without a chemical catalyst, and the “chemical imidization process” refers to a process in which a dehydrating agent and an imidizing agent are employed.

The polyimide film thus manufactured is suitable for use as a protective film or a carrier film, but with no limitations thereto. The polyimide film can find applications in various fields demanding such properties.

### MODE FOR CARRYING OUT THE INVENTION

Below, a better understanding of the present disclosure may be obtained via the following examples which are set forth to illustrate, but are not to be construed as limiting, the present disclosure.

### Preparatich Example: Manufacture of Polyimide Film

A polyimide film may be manufactured using a typical method known in the art, as follows. First, the acid dianhydride and diamine components described in the foregoing are reacted with each other in an organic solvent to give a poly(amic acid) solution.

The solvent may be typically an amide-based solvent which is aprotic. For example, N,N′-dimethylformamide, N,N′-dimethylacetamide, N-methyl pyrrolidone, or a combination thereof may be used.

The acid dianhydride and diamine components may be fed in the form of a powder, a lump, or a solution. At the initial stage of reaction, the components may be fed in the form of powders. After the reaction proceeds to some extent, a solution form is preferred for adjusting the viscosity of the polymer.

The poly(amic acid) solution thus obtained may be applied in mixture of an imidizing catalyst and a dehydrating agent to a support.

Examples of the catalyst include tertiary amines (e.g., isoquinoline, B-picoline, pyridine, and so on) and the dehydrating agent may be exemplified by anhydrous acids, but with no limitations thereto. In addition, examples of the support include, but are not limited to, a glass plate, an aluminum foil, a circulating stainless belt, and a stainless drum.

The solution cast on the support is gelled into a film by treatment with dry air and heat.

After being separated from the support, the gelled film is dried by thermally treatment to the completion of imidization.

The thermally treated film is again thermally treated under uniform tension to eliminate the residual stress generated inside the film during film formation.

In detail, 500 ml of DMF was input into a reactor equipped with a stirrer and nitrogen introduction/release tubes while nitrogen was injected thereinto. The temperature of the reactor was set to be 30° C. before 3,3′,4,4′-benzophenonetetracarboxylic dianhydride (BTDA), 3,3′,4,4′-biphenyltetracarboxylic dianhydride (BPDA), pyromellitic dianhydride (PMDA), 4,4′-oxydianiline (ODA), p-phenylenediamine (PPD), and 3,5-diaminobenzoic acid (DABA) were fed at controlled ratios and completely dissolved. Then, the temperature of the reactor was increased to 40° C. in a nitrogen atmosphere while stirring for 120 minutes. As a result, a primary poly(amic acid) with a viscosity of 1,500 cP was obtained.

To the poly(amic acid), a pyromellitic dianhydride (PMDA) solution was added, followed by stirring to a final viscosity of 100,000-120,000 cP.

This final poly(amic acid) was added with a controlled amount of the phosphorus-based compound triphenyl phosphate (TPP), along with a catalyst ad a dehydrating agent and then formed into a highly thick polyimide film, using an applicator.

### Examples and Comparative Examples

Polyimide films were prepared in the same manner as in the Preparation Example, wherein the acid dianhydride component included 17 mol % of 3,3′,4,4′-benzophenonetetracarboxylic dianhydride (BTDA), 53 mol % of 3,3′,4,4′-biphenyltetracarboxylic dianhydride (BPDA), and 30 mol % of pyromellitic dianhydride (PMDA) and was reacted at a ratio of 100 mol %:100 mol % with the diamine component.

Based on a total of 100 mol % of the diamine component, a content was set forth to be 20 mol % for 4,4′-oxydianiline (ODA), 66.5 mol % for p-phenylenediamine (PPD), and 13.5 mol % for 3,5-diaminobenzoic acid (DABA).

As shown in Table 1, below, the content of triphenyl phosphate (TPP) was adjusted relative to the solid content of the acid dianhydride and diamine components, and the resulting polyimide films were all 75 μm thick.

TABLE 1

| | TPP Content | Mean No. of | Elastic Modulus |
|---|---|---|---|
| Example # | (%) | bubble (ea/m²) | (GPa) |
| Ex. 1 | 1.5 | 4 | 6.90 |
| Ex. 2 | 2.0 | 2 | 6.90 |
| Ex. 3 | 2.5 | 0 | 6.85 |
| Ex. 4 | 3.0 | 0 | 6.70 |
| Ex. 5 | 3.5 | 0 | 6.65 |
| Ex. 6 | 4.0 | 0 | 6.60 |
| C. Ex. 1 | 0.0 | 132 | 7.10 |
| C. Ex. 2 | 0.1 | 121 | 7.05 |
| C. Ex. 3 | 0.5 | 55 | 7.00 |
| C. Ex. 4 | 1.0 | 13 | 7.00 |
| C. Ex. 5 | 5.0 | 0 | 5.95 |
| C. Ex. 6 | 6.0 | 0 | 5.75 |
| C. Ex. 7 | 7.0 | 0 | 5.51 |
| C. Ex. 8 | 10.0 | 0 | 3.13 |

All of the polyimide films prepared in the Examples and the Comparative Examples were measured for arithmetic mean surface roughness (Ra) using a surface roughness measuring instrument from Kosaka Laboratory Ltd.

All the polyimide films of the Examples and the Comparative Examples measured had a surface roughness of 0.5 μm or less.

For the elastic modulus of all of the polyimide films prepared in the Examples and the Comparative Examples, mean values of three measurements obtained according to ASTM D 882 using a Standard Instron testing apparatus were taken.

The mean numbers of bubbles were determined by counting bubbles with the naked eye in the images which were taken using a film defective analyzer equipped with an imaging device.

In this regard, film specimens with a certain width and length were sampled and bubbles therein were counted. Then, the bubble measurements were converted into counts per m².

According to the measurement results, although highly thick, the polyimide films of Examples 1 to 6 in which triphenyl phosphate (TPP) was added at a content of 1.5% by weight to 4.5% by weight retained a greatly reduced number of bubbles, compared to that of Comparison Example 1 using no triphenyl phosphate (TPP) (132 bubbles per 1 m²) or those of Comparison Examples 2 to 4 using less than 1.5% by weight of triphenyl phosphate (TPP).

Among others, zero bubbles were observed at a content of 2.5% by weight or more of triphenyl phosphate (TPP).

In addition, the polyimide films containing 1.5% by weight to 4.0% by weight of triphenyl phosphate (TPP) (Examples 1 to 6) tended to slightly decrease in elastic modulus, compared to Comparative Examples 1 to 4, but maintained the elastic modulus at 6 GPa or higher (6.6 GPa-6.9 GPa), which are sufficient for application to articles, without any problems.

An increase of the content of triphenyl phosphate (TPP) to 5.0% by weight or greater (Comparative Examples 5 to 8) greatly reduced the elastic modulus to less than 6 GPa although no bubbles were generated.

A decrease in elastic modulus with increasing of the content of triphenyl phosphate (TPP) is considered to be attributed to the plasticizer properties of triphenyl phosphate (TPP).

Embodiments for the polyimide film and the method of manufacturing a polyimide film according to the present disclosure are only illustrative, but not limitative so as for those skilled in the art to easily implement the present disclosure. Accordingly, the scope of the present disclosure is not limited thereto. Therefore, the true technical protection scope of the present invention should be determined by the technical spirit of the appended claims. In addition, it should be understood by those skilled in the art that various applications and modifications may be made without departing from the scope of the present disclosure.

### INDUSTRIAL APPLICABILITY

The present disclosure provides a highly thick polyimide film having high elasticity and high heat resistance, wherein ratios and solid contents of acid dianhydride and diamine components are controlled and a phosphorus-based compound is contained, whereby the polyimide film has an elastic modulus of 6 GPa or higher, a surface roughness of 0.5 μm or less, and a thickness of 70 μm or greater.

With excellent mechanical property of high elasticity, low surface roughness, and restrained bubble formation, the polyimide can find advantageous applications in various fields demanding such versatile properties.

1. A polyimide film, obtained by imidizing a poly(amic acid) solution containing an acid dianhydride component including 3,3′,4,4′-benzophenonetetracarboxylic dianhydride (BTDA), 3,3′,4,4′-biphenyltetracarboxylic dianhydride (BPDA), and pyromellitic dianhydride (PMDA), and a diamine component including 4,4′-oxydianiline (ODA), para-phenylenediamine (p-phenylenediamine, PPD), and 3,5-diaminobenzoic acid (DABA),
wherein the 4,4′-oxydianiline is used at a content of 10 mol % to 30 mol %, the p-phenylenediamine is used at a content of 50 mol % to 70 mol %, and the 3,5-diaminobenzoic acid is used at a content of 5 mol % to 25 mol %, based on a total of 100 mol % of the diamine component, and
the polyimide film comprises a phosphorus (P)-based compound.

2. The polyimide film of claim 1, wherein the 3,3′,4,4′-benzophenonetetracarboxylic dianhydride is used at a content of 10 mol % to 30 mol %, the 3,3′,4,4′-biphenyltetracarboxylic dianhydride is used at a content of 40 mol % to 70 mol %, and the pyromellitic dianhydride is used at a content of 10 mol % to 50 mol %, based on a total of 100 mol % of the acid dianhydride component.

3. The polyimide film of claim 1, wherein the phosphorus-based compound is contained in an amount of 1.5% by weight to 4.5% by weight, relative to the solid content of the acid dianhydride component and the diamine component.

4. The polyimide film of claim 1, wherein the phosphorus-based compound is at least one selected from the group consisting of triphenyl phosphate, trixylenyl phosphate, tricresyl phosphate, resorcinol diphenyl phosphate, and ammonium polyphosphate.

5. The polyimide film of claim 1, wherein the polyimide has an elastic modulus of 6 GPa or higher, a surface roughness of 0.5 μm or less, and a thickness of 70 μm or greater.

6. The polyimide film of claim 1, wherein the polyimide film has less than 5 bubbles per 1 m² thereof.

7. A method for manufacturing a polyimide film, the method comprising the steps of:
(a) polymerizing an acid dianhydride including 3,3′,4,4′-benzophenonetetracarboxylic dianhydride (BTDA), 3,3′,4,4′-biphenyltetracarboxylic dianhydride (BPDA), and pyromellitic dianhydride (PMDA) with a diamine component including 4,4′-oxydianiline (ODA), p-phenylenediamine (PPD), and 3,5-diaminobenzoic acid (DABA) in an organic solvent to prepare a poly(amic acid);
(b) adding and mixing the poly(amic acid) of step (a) with an imidizing catalyst and a phosphorus (P)-based compound; and
(c) imidizing the poly(amic acid) of step (b),
wherein the 4,4′-oxydianiline is used at a content of 10 mol % to 30 mol %, the p-phenylenediamine is used at a content of 50 mol % to 70 mol %, and the 3,5-diaminobenzoic acid is used at a content of 5 mol % to 25 mol %, based on a total of 100 mol % of the diamine component.

8. The method of claim 7, wherein the phosphorus-based compound is contained in an amount of 1.5% by weight to 4.5% by weight, relative to the solid content of the acid dianhydride component and the diamine component.

9. The method of claim 7, wherein the phosphorus-based compound is at least one selected from the group consisting of triphenyl phosphate, trixylenyl phosphate, tricresyl phosphate, resorcinol diphenyl phosphate, and ammonium polyphosphate.

10. The method of claim 7, wherein the polyimide has an elastic modulus of 6 GPa or higher, a surface roughness of 0.5 μm or less, and a thickness of 70 μm or greater.

11. The polyimide film of claim 1, wherein the polyimide film is used as a protective film or a carrier film.
